(19) United States
(12) Patent Application Publication
(10) Pub. No.: US 2024/0422565 A1
(43) Pub. Date: Dec. 19, 2024

(54) SYSTEMS, METHODS, AND APPARATUSES FOR NETWORK MANAGEMENT

(71) Applicant: Comcast Cable Communications, LLC, Philadelphia, PA (US)

(72) Inventor: Glenn Perkins, Philadelphia, PA (US)

(21) Appl. No.: 18/210,473

(22) Filed: Jun. 15, 2023

(51) Int. Cl. H04W 16/14; H04W 52/24; H04W 72/044

(52) U.S. Cl. CPC H04W 16/14; H04W 52/243; H04W 72/046; H04W 84/12

(57) ABSTRACT

Methods, systems, and apparatuses for network management are disclosed. For example, one or more network identifiers (e.g., Basic Service Set (BSS) color parameters) may be used to mitigate co-channel interference by causing a communication device to switch to a different channel, by causing a communication device to adjust transmit power, and/or to cause a communication device to selectively send spatial reuse (SR) transmissions.

### BACKGROUND

With rapid increase in the number of Institute of Electrical and Electronics Engineers (IEEE) 802.11 devices (e.g., client stations (STAs)) and/or access points (APs)) being added to wireless local area network (WLAN) based networks, dense WLAN deployments have become commonplace. Such dense WLAN deployments face significant performance issues due to factors including, for example, interference, congestion, low throughput, etc.

For example, high levels of interference brought about by large numbers of users threatens to degrade the levels of network performance that users have come to expect. The IEEE 802.11 networks have continued to evolve in an attempt to address these challenges. These challenges have been addressed to some extent by introducing Dynamic Sensitivity Control (DSC) and Basic Service Sets (BSS) color schemes in IEEE 802.11ax and IEEE 802.11ah implementations, respectively. These schemes are intended to improve network throughput and spectrum efficiency in dense environments.

Particularly, BSS Coloring was introduced in 802.11ah to increase the network capacity in dense environments by improving the ability to reuse frequencies. BSS color may be used to differentiate between intra-BSS frames and Overlapping BSS (OBSS) frames, and to determine which Clear Channel Assessment (CCA) threshold to use while accessing the shared channel resource in the same frequency range.

However, such techniques reuse frequencies within the same communication channel. No WLAN features exist that utilize BSS color to resolve interference via alternate communication channels, adjusted transmit power levels, and/or selective Spatial Reuse (SR) transmissions.

### SUMMARY

It is to be understood that both the following general description and the following detailed description are exemplary and explanatory only and are not restrictive, as claimed. Methods, systems, and apparatuses for network management are disclosed. Methods, systems, and apparatuses are disclosed for determining a channel for use by the one or more access points (APs), and associated client stations, based at least in part on network identifiers, for example, based on Basic Service Set (BSS) color parameters. Methods, systems, and apparatuses are disclosed for causing adjustment of one or more transmission power levels of one or more APs based at least in part on network identifiers, for example, based on BSS color parameters. Methods, systems, and apparatuses are disclosed for causing one or more APs that are configured for spatial reuse transmission to send a spatial reuse transmission to certain client stations and not to certain other client stations based at least in part on network identifiers, for example, based on BSS color parameters.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, serve to explain the principles of the apparatuses, methods, and systems described herein:

FIG. 1 shows an example system:

FIG. 2 shows an example packet header:

FIG. 3 shows an example system:

FIG. 4 shows an example method:

FIG. 5 shows an example system:

FIG. 6 shows an example method:

FIG. 7 shows an example system:

FIG. 8 shows an example Spatial Reuse directory:

FIG. 9 shows an example method:

FIG. 10 shows an example method:

FIG. 11 shows an example method:

FIG. 12 shows an example method; and

FIG. 13 shows an example system.

### DETAILED DESCRIPTION

Before the present methods and systems are described, it is to be understood that the methods and systems are not limited to specific methods, specific components, or to particular implementations. It is also to be understood that the terminology used herein is for the purpose of describing particular examples only and is not intended to be limiting.

As used in the specification and the appended claims, the singular forms “a,” “an,” and “the” include plural referents unless the context clearly dictates otherwise.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment and/or example. “Such as” is not used in a restrictive sense, but for explanatory purposes.

Described are components that can be used to perform the described methods and systems. These and other components are described herein, and it is understood that when combinations, subsets, interactions, groups, etc. of these components are described that while specific reference of each various individual and collective combinations and permutation of these may not be explicitly described, each is specifically contemplated and described herein, for all methods and systems. This applies to all aspects of this application including, but not limited to, steps in the described methods. Thus, if there are a variety of additional steps that can be performed it is understood that each of these additional steps can be performed with any specific example or combination of examples of the described methods.

The present methods and systems may be understood more readily by reference to the following detailed description and the examples included therein and to the Figures and their previous and following description. As will be appreciated by one skilled in the art, the methods and systems may take the form of an entirely hardware embodiment and/or an entirely software embodiment and/or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, flash memory internal or removable storage devices, or magnetic storage devices.

Examples of the apparatuses, methods, and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions, and program instruction means for performing the specified functions. It will also be understood that each block of the block diagrams and flowchart illustrations, and combinations of blocks in the block diagrams and flowchart illustrations, can be implemented by special purpose, hardware-based computer systems that perform the specified functions or steps, or combinations of special purpose hardware and computer instructions.

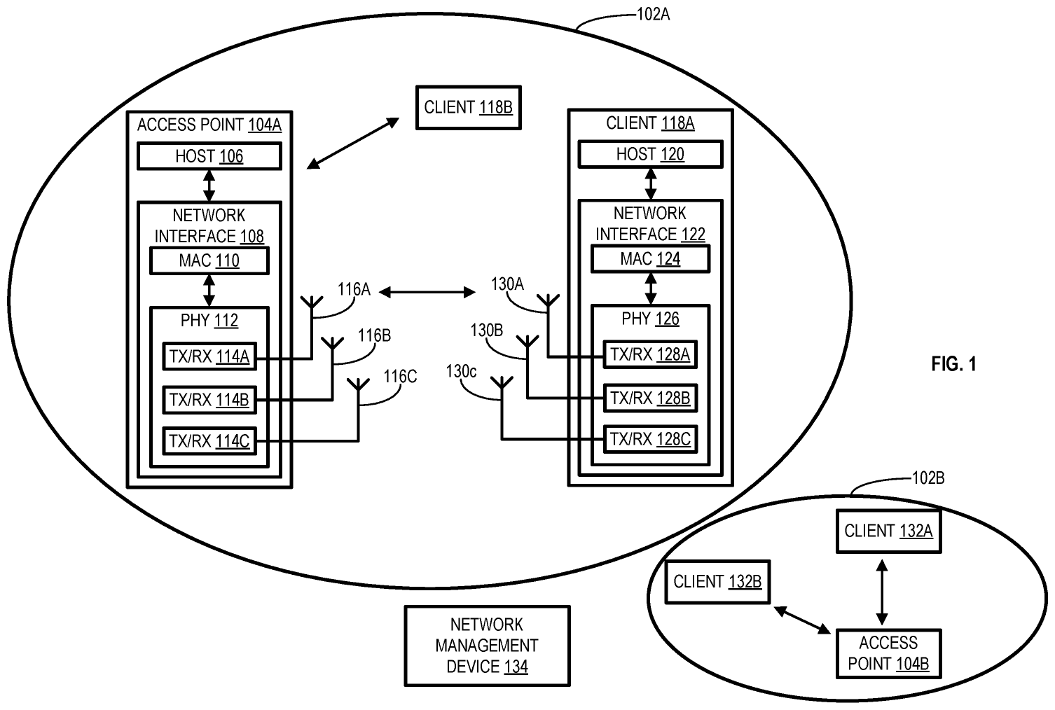

FIG. 1 is a block diagram of an example communication system that may include, for example, multiple wireless local area networks (WLANs) 102A-B. A first WLAN 102A includes an access point (AP) 104A that comprises a host processor 106 coupled to a network interface 108. The network interface 108 includes a medium access control layer (MAC) processor 110 and a physical layer (PHY) processor 112. The PHY processor 112 includes a plurality of transceivers 114A-C. The transceivers 114A-C may be coupled to a plurality of antennas 116A-C. Although three transceivers 114A-C and three antennas 116A-C are illustrated in FIG. 1, the AP 104A may include other suitable numbers (e.g., 1, 2, 4, 5, etc.) of transceivers 114A-C and antennas 116A-C in other examples. For example, the AP 104A may include a higher number of antennas 116A-C than transceivers 114A-C, and antenna switching techniques may be utilized.

The network interface 108 may be implemented using one or more integrated circuits (ICs) configured to operate as discussed below. For example, the MAC processor 110 may be implemented, at least partially, on a first IC, and the PHY processor 112 may be implemented, at least partially, on a second IC. As another example, at least a portion of the MAC processor 110 and at least a portion of the PHY processor 112 may be implemented on a single IC. For instance, the network interface 108 may be implemented using a system on a chip (SoC), where the SoC includes at least a portion of the MAC processor 110 and at least a portion of the PHY processor 112.

For example, the MAC processor 110 and/or the PHY processor 112 of the AP 104A may be configured to generate data units, and process received data units, that conform to a WLAN communication protocol such as a communication protocol conforming to the IEEE 802.11 Standard or another suitable wireless communication protocol. For example, the MAC processor 110 may be configured to implement MAC layer functions, including MAC layer functions of the WLAN communication protocol, and the PHY processor 112 may be configured to implement PHY functions, including PHY functions of the WLAN communication protocol. For instance, the MAC processor 110 may be configured to generate MAC data units, such as MAC service data units (MSDUs), MAC protocol data units (MPDUs), etc., and provide the MAC data units to the PHY processor 112. The PHY processor 112 may be configured to receive MAC data units from the MAC processor 110 and encapsulate the MAC data units to generate PHY data units such as PHY protocol data units (PPDUs) for transmission via the antennas 116A-C. Similarly, the PHY processor 112 may be configured to receive PHY data units that were received via the antennas 116A-C, and extract MAC data units encapsulated within the PHY data units. The PHY processor 112 may provide the extracted MAC data units to the MAC processor 110, which processes the MAC data units.

The first WLAN 102A may include a plurality of client stations A-B. Although two client stations 118A-B are illustrated in FIG. 1, the first WLAN 102A may include other suitable numbers (e.g., 1, 3, 4, 5, 6, etc.) of client stations 118A-B in other examples. The client stations 118A-B may be any suitable communication device operable to compute, classify, process, transmit, receive, retrieve, originate, switch, store, display, manifest, detect, record, reproduce, handle, or utilize any form of information, intelligence, or data for business, scientific, control, entertainment, or other purposes. For example, a client station 118A-B may be a personal computer, a PDA, a consumer electronic device, a network server or storage device, a switch router or other network communication device, or any other suitable device and may vary in size, shape, performance, and functionality. The client station 118A-B may include memory, one or more processing resources, such as a central processing unit (CPU), or hardware or software control logic. Additional components of the client station 118A-B may include one or more storage devices, one or more communications ports for communicating with external devices, as well as various other I/O devices, such as a keyboard, a mouse, and a video display. The client station 118A-B may also include one or more busses operable to transmit communications between the various hardware components. The client station 118A-B may include a set of instructions that may be executed to cause the client station 118 to perform any one or more of the methods or computer-based functions disclosed herein.

The client station 118A may comprise a host processor 120 coupled to a network interface 122. The network interface 122 may comprise a MAC processor 124 and a PHY processor 126. The PHY processor 126 may comprise a plurality of transceivers 128A-C. The transceivers 128A-C may be coupled to a plurality of antennas 130A-C. Although three transceivers 128A-C and three antennas 130A-C are illustrated in FIG. 1, the client station 118A may include other suitable numbers (e.g., 1, 2, 4, 5, etc.) of transceivers 128A-C and antennas 130A-C in other examples. For example, the client station 118A may include a higher number of antennas 130A-C than transceivers 128A-C, and antenna switching techniques may be utilized.

The network interface 122 may be implemented using one or more ICs configured to operate as discussed below. For example, the MAC processor 124 may be implemented on at least a first IC, and the PHY processor 126 may be implemented on at least a second IC. As another example, at least a portion of the MAC processor 124 and at least a portion of the PHY processor 126 may be implemented on a single IC. For instance, the network interface 122 may be implemented using an SoC, where the SoC includes at least a portion of the MAC processor 124 and at least a portion of the PHY processor 126.

For example, the MAC processor 124 and the PHY processor 126 of the client station 118A may be configured to generate data units, and process received data units, that conform to the WLAN communication protocol or another suitable communication protocol. For example, the MAC processor 124 may be configured to implement MAC functions, including MAC functions of the WLAN communication protocol, and the PHY processor 126 may be configured to implement PHY functions, including PHY functions of the WLAN communication protocol. The MAC processor 124 may be configured to generate MAC data units, such as MSDUs, MPDUs, etc., and provide the MAC data units to the PHY processor 126. The PHY processor 126 may be configured to receive MAC layer data units from the MAC processor 124 and encapsulate the MAC data units to generate PHY data units such as PPDUs for transmission via one or more of the antennas 130A-C. Similarly, the PHY processor 126 may be configured to receive PHY data units that were received via one or more of the antennas 130A-C, and extract MAC data units encapsulated within the PHY data units. The PHY processor 126 may provide the extracted MAC data units to the MAC processor 124, which processes the MAC data units.

For example, the client station 118b has a structure that is the same as or similar to the client station 118A. The client station 118b structured the same as or similar to the client station 118A has the same or a different number of transceivers and antennas. For example, the client station 118b may only have two transceivers and two antennas.

The system illustrated in FIG. 1 may also include a second WLAN 102B. The second WLAN 102B may include an AP 104B and a plurality of client stations 132A-B. For example, the AP 104B may have a structure that is the same as or similar to the AP 104A. The AP 104B, structured the same as or similar to the AP 104A, may have the same or a different number of transceivers and antennas. For example, the AP 104B may only have two transceivers and two antennas.

For example, the client stations 132A-B may each have a respective structure that is the same as or similar to the client station 118A. Each client station 132A-B, structured the same as or similar to the client station 118A, may have the same or a different number of transceivers and antennas. For example, the client station 132A may only have two transceivers and two antennas.

Although two client stations 132A-B are illustrated in FIG. 1, the second WLAN 102B may include other suitable numbers (e.g., 1, 3, 4, 5, 6, etc.) of client stations 132A-B in various examples.

Wireless networks such as the WLANs 102A-B may be referred to as basic service sets (BSSs). When transmissions from one BSS are received by devices in another BSS, and vice-versa, the BSSs may be referred to as overlapping BSSs (OBSSs). For example, in one scenario, the second WLAN 102B is an OBSS with respect to the first WLAN 102A, and vice-versa.

For example, the APs 104 and the client stations 118A-B/132A-B may contend for a communication medium using carrier sense multiple access with a collision avoidance (CSMA/CA) protocol or another suitable medium access protocol.

The 802.11 Wi-Fi standard minimizes the chance of multiple devices interfering with one-another by transmitting at the same time. CSMA/CA protocols are based on static thresholds that allow Wi-Fi devices to avoid interfering with each other on air. However, with an increase in the density and the number of Wi-Fi devices, these static thresholds often lead to CSMA/CA causing devices to defer transmissions unnecessarily. For example, if two devices that are associated with different BSSs can hear transmissions from each other at relatively low signal strengths, each device should defer its transmission when it receives a transmission from the other. But if both the devices were to transmit at the same time, it is likely that neither would cause enough interference at the other BSS receiver to cause reception failure for either transmission.

Conventional client stations must demodulate packets to examine the MAC header in order to determine whether or not a received packet belongs to their own BSS. This process of demodulation consumes power, which can be saved if devices can quickly identify the BSS by looking at the PHY header alone, and subsequently drop packets that are from a different BSS.

The 802.11ax (Wi-Fi 6) standard addresses both of the issues discussed above, through the BSS Coloring and Spatial Reuse (SR) mechanism. BSS Coloring is a provision that allows devices operating in the same frequency space to quickly distinguish between packets from their own BSS and packets from an OBSS, by looking at the BSS color parameter contained in the PHY header. For example, spatial reuse allows devices to transmit at the same time as the OBSS packets they receive, instead of deferring transmissions because of legacy interference thresholds. Since every Wi-Fi 6 device understands the BSS color parameter, it can be leveraged to increase power savings by dropping packets earlier, and, in some instances, to identify spatial reuse opportunities even if the Wi-Fi 6 device does not support spatial reuse.

In accordance with the CSMA/CA protocol described above, a communication device (e.g., client stations 118A-B and/or AP 104A) within the first WLAN 102A will generally not be permitted to transmit while another communication device within the first WLAN 102A is transmitting (referred to as a same-BSS or intra-BSS transmission). However, if a communication device in the first WLAN 102A determines that a transmission is from another network (e.g., the second WLAN 102B) (referred to as an OBSS or inter-BSS transmission), the communication device in the first WLAN 102A may be permitted to transmit during the OBSS transmission, if configured to support spatial reuse. Such a transmission is referred to herein as a spatial reuse transmission. The transmit power of an SR transmission in the first WLAN 102A may be reduced (e.g., as compared to a non-SR transmission) to mitigate degradation of the transmission in the second WLAN 102B.

In order for a communication device (e.g., client stations 118A-B and/or AP 104) that is compliant with a communication protocol (e.g., the IEEE 802.11ax protocol, or another suitable wireless communication protocol) to determine whether a given transmission corresponds to a same-BSS or to an OBSS, the device may obtain a BSS color parameter from a PHY header (e.g., within a high efficiency signal field A (HE-SIGA)) in the transmission, and may compare the BSS color parameter in the PHY header to a BSS color parameter of the BSS to which the device (e.g., client stations 118A-B and/or AP 104) belongs.

The BSS color parameter may comprise a numerical identifier of the BSS (e.g., a BSS color may be an identifier of a wireless network, such as the first WLAN 102A or the second WLAN 102B). 802.11ax radios may be configured to differentiate between BSSs using BSS color parameters when other radios transmit on the same channel. If the BSS color parameter is the same, this is considered to be an intra-BSS frame transmission because the transmitting radio belongs to the same BSS as the receiver. If the detected frame has a different BSS color parameter from its own, then the client station considers that frame as an inter-BSS frame from an overlapping BSS (e.g., the second WLAN 102B with respect to the first WLAN 102A). One or more APs may be configured to select a BSS color parameter. For example, AP 104A may select a BSS color parameter for the first WLAN 102A and communicate the chosen BSS color to client stations 118A-B within the first WLAN 102A (e.g., via beacon frames, control frames, etc.). A network management device 134 may be configured to select and/or assign BSS color parameters to one or more APs (e.g., APs 104A-B). The network management device 134 may be configured to select and/or assign channels to one or more APs (e.g., APs 104A-B) for communications with client stations. The network management device 134 may be implemented as an instance of an access point. The network management device 134 may be a network server or other suitable computing device.

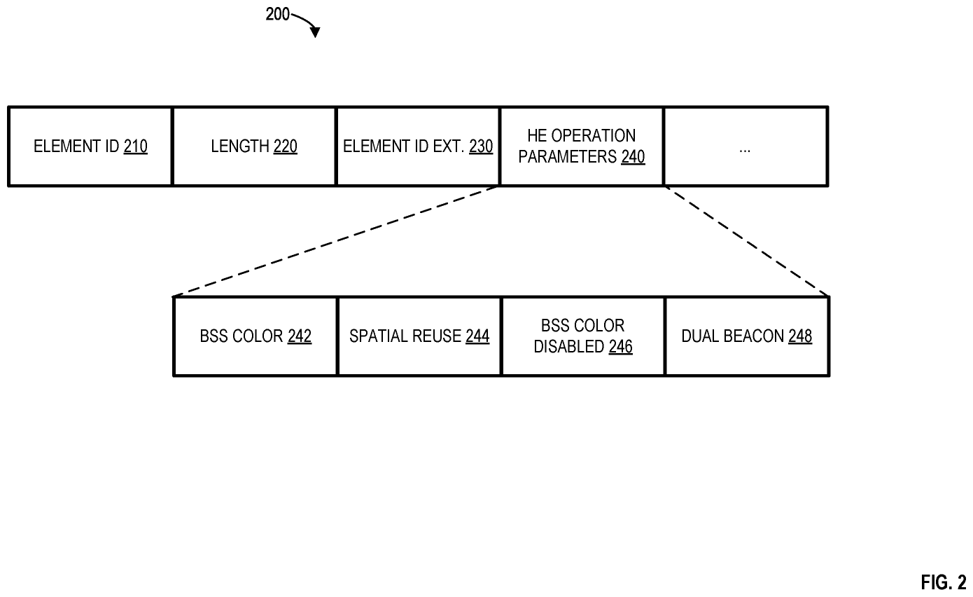

BSS color parameters may be communicated at both the PHY layer and the MAC sublayer. For example, in the preamble of an 802.11ax PHY header, the SIG-A field contains a 6-bit BSS color field. This field may identify as many as 64 BSS color parameters. As shown in FIG. 2, the BSS color parameter may be present in 802.11 management frames. The HE operation information element contains a subfield of BSS color information. Six bits can be used to identify as many as 64 different colors and represent 64 different BSSs.

FIG. 2 shows an example HE Operation element 200 that may be provided in beacon (or other management) frames transmitted by the APs 104A-B. The HE Operation element 200 may include an “Element ID” field 210, a “Length” field 220, an “Element ID Extension” field 230, an “HE Operation Parameters” field 240, and one or more additional fields for optional sub-elements (not shown for simplicity). The Element ID field 210 may store 1 byte of information identifying the element 200 as an HE Operation element. The Length field 220 may store 1 byte of information indicating the length of the HE Operation element 200. The Element ID Extension field 230 may store an additional byte of information as an extension to the Element ID field 210. The HE Operation Parameters field 240 may store up to 4 bytes of information indicating one or more HE operations or parameters supported by the AP or BSS associated with the HE Operation element 200.

The HE Operation Parameters field 240 may include a “BSS Color” subfield 242. “Spatial Reuse” subfield 244, a “BSS Color Disabled” subfield 246, and a “Dual Beacon” subfield 248. The BSS Color subfield 242 may store up to 6 bits of information indicating a BSS color associated with the AP or BSS. For example, the BSS color may be used to differentiate communications intended for a particular BSS from communications intended for an overlapping BSS or any other BSSs in the vicinity. The Spatial Reuse subfield 244 may indicate whether an AP and/or a client station supports spatial reuse transmissions. If an AP and/or client stations supports spatial reuse transmissions, the field may also indicate the limit on the transmission power to be used during the spatial reuse transmission opportunities that can potentially be detected. A single Spatial Reuse subfield (of length of 4 bits) may be carried in HE SU/MU/ER PPDUs, while HE TB PPDUs may include up to four spatial reuse fields. In particular, each spatial reuse field may be meant for the spatial reuse transmission operation in each allowed channel width (e.g., 20 MHZ, 40 MHZ, 80 MHZ, and 160 MHZ). The BSS Color Disabled subfield 246 may store 1 bit of data indicating whether a BSS color check procedure should be disabled (or enabled) for the corresponding BSS. For example, a value of 0) in the BSS Color Disabled subfield 246 may indicate that the BSS color check procedure should be enabled (causing HE devices to filter incoming communication frames based on the BSS color indicated in the BSS Color subfield 242). A value of 1 in the BSS Color Disabled subfield 246 may indicate that the BSS color check procedure should be disabled (causing HE devices to ignore the BSS color of incoming communication frames). The Dual Beacon subfield 248 may store at least 1 bit of data indicating whether the originating AP transmits beacon frames in multiple PHY formats. For example, a value of 0) in the Dual Beacon subfield 248 may indicate that the AP transmits beacons in the primary frame format. A value of 1 in the Dual Beacon subfield 248 may indicate that the AP transmits beacons in the primary frame format and the secondary frame format.

For example, an HE AP may support multiple PHY formats through a single BSS. For example, the AP may operate as a single BSS configured for dual beacon functionality. Thus, the AP may transmit communication frames formatted in accordance with the primary frame format and the secondary frame format on behalf of the same BSS. For example, the AP may advertise its support for dual beacon functionality, for example, by storing a value of 1 in the Dual Beacon subfield 248 of beacon (or other management) frames transmitted by the AP.

For example, an HE AP may support multiple PHY formats through multiple BSSs. For example, the AP may operate as a plurality of “virtual” BSSs that are individually configured for a particular PHY format. Thus, the AP may transmit communication frames formatted in accordance with the primary frame format on behalf of a first (virtual) BSS and may transmit communication frames formatted in accordance with the secondary frame format on behalf of a second (virtual) BSS. The AP may be configured to transmit communication frames formatted in accordance with the primary frame format on behalf of the first (virtual) and in accordance with the secondary frame format on behalf of the second (virtual) BSS on the same channel using different BSS color parameters or on a different channel using the same, or different, BSS color parameters. In these examples, the AP may advertise that it does not support dual beacon functionality, for example, by storing a value of 0) in the Dual Beacon subfield 248 of beacon (or other management) frames transmitted by the AP. Further, when operating as a plurality of BSSs, an AP may advertise the presence of co-located BSSs (that support different PHY formats).

It is noted that different frame formats may perform better than others under different channel conditions or distances between wireless devices. For example, the extended range (ER) format (included in the IEEE 802.1 lax specification) is a particular PHY format that may allow wireless device to communicate more effectively over greater distances than legacy or non-ER frame formats. The ER format may offer more robust performance over longer distances, for example, by boosting the power and repeating the information carried in the communication frames. However, this feature also may reduce the rate at which data can be transmitted, thus making the ER frame format less desirable (compared to non-ER frame formats) for close-range communications. Thus, client stations that are closer in proximity to an HE AP may prefer to communicate using a non-ER format, whereas client stations that are further from the AP may prefer to communicate using the ER format.

Channel access may be dependent on the BSS color parameter detected, with the BSS color parameter indicating whether an incoming frame is an OBSS frame transmission (different BSS) or an intra-BSS frame transmission (same BSS). Spatial reuse operations may use the BSS color parameter to apply adaptive clear channel assessment (CCA) thresholds for detected OBSS frame transmissions. The goal of BSS coloring with spatial reuse is to ignore transmissions from an OBSS and therefore be able to transmit at the same time as transmissions occurring for the OBSS. Client stations applying spatial reuse may use the default CCA/CS threshold (e.g., −82 dBm) upon detecting intra-BSS frames. On the contrary, when OBSS frames are detected, more aggressive preamble-detection (PD) thresholds can be applied to increase the number of parallel transmissions.

Returning to FIG. 1, if a communication device (e.g., client stations 118A-B and/or AP 104) determines that a BSS color parameter in a PHY header of a packet (e.g., a preamble such as HE preamble and/or EHT preamble) is the same as a BSS color parameter of the wireless network to which the communication belongs, the communication device concludes that the packet corresponds to a same-BSS transmission and may wait for a clear channel before communicating. If the BSS color parameter in the PHY header of the packet is different than the BSS color parameter of the wireless network to which the communication belongs, then the communication device concludes that the packet corresponds to an OBSS transmission and may therefore treat the OBSS transmission as background noise. If the packet corresponds to an OBSS transmission, the communication device, if configured to support spatial reuse, may determine whether conditions for a spatial reuse transmission are or can be satisfied.

Some or all communication devices (e.g., client stations 118A-B, 132A-B and/or APs 104A-B) may not be capable of, or configured for, spatial reuse transmission. However, such communication devices may still be capable of, and/or configured for, reading and/or reporting BSS color parameters. For example, methods are disclosed for unconventional uses of a BSS color parameter, including in communication environments comprising one or more APs configured for spatial reuse transmission and one or more client stations not configured for spatial reuse transmission.

The network management device 134, and/or one or more APs (e.g., AP 104A and/or AP 104B) may be configured to determine a channel for use by the one or more APs based at least in part on BSS color parameters. The network management device 134, and/or the one or more APs (e.g., AP 104A and/or AP 104B) may be configured to cause adjustment of one or more transmission power levels of the one or more APs based at least in part on BSS color parameters. The network management device 134, and/or one or more APs (e.g., AP 104A and/or AP 104B) may be configured to cause one or more APs that are configured for spatial reuse transmission to send a spatial reuse transmission to certain client stations (e.g., client stations 118A-B and/or client stations 132A-B) and not to certain other client stations (e.g., client stations 118A-B and/or client stations 132A-B) based at least in part on BSS color parameters.

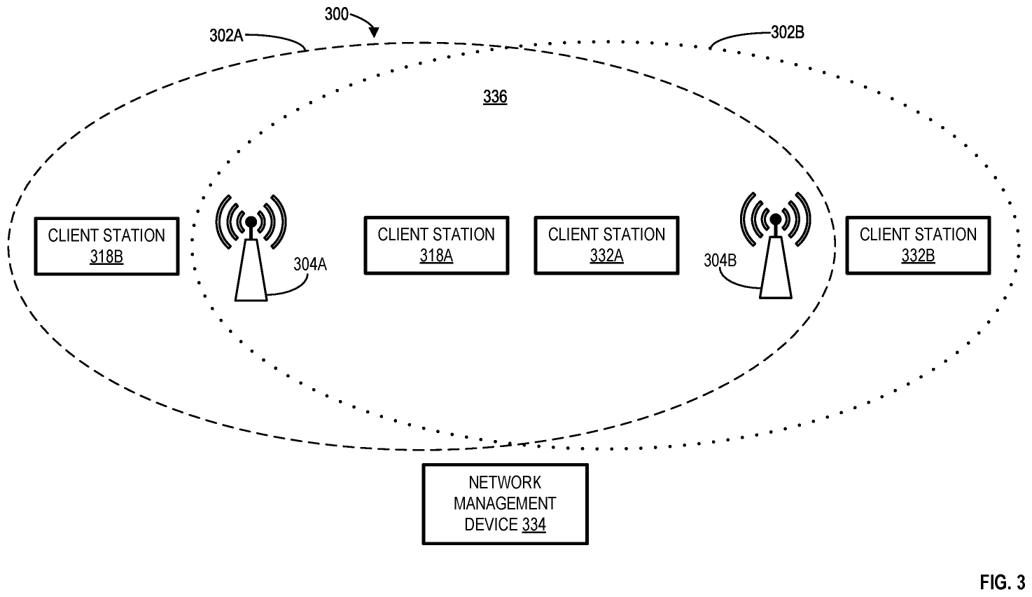

FIG. 3 shows an example system 300 having a first access point 304A, a second access point 304B, a client station 318A, a client station 318B, a client station 332A, and a client station 332B. While only two access points and four client stations are shown in FIG. 3, in other examples, the system 300 may include other suitable numbers of access points and other suitable numbers of client stations. The first access point 304A and the second access point 304B may be implemented as instances of the access points 104A and/or 104B described above with reference to FIG. 1. For example, the client stations 318A, 318B, 332A, and/or 332B may be implemented as an instance of the client stations 118A, 118B, 132A, and/or 132B described above with reference to FIG. 1. The first access point 304A and the second access point 304B may communicate with client stations by transmitting/sending and/or receiving data units and/or frames, for example, orthogonal frequency division multiplexing (OFDM) data units. For example, the OFDM data units may include an MPDU having a reduced header length using a BSS color identifier or other suitable non-unique identifier for the corresponding access point. For example, the data units may include scheduling frames for uplink orthogonal frequency division multiple access (OFDMA). For example, the data units may include the BSS color identifier in a PHY field, for example, the BSS color field 242 of the frame, as shown in FIG. 2.

The first access point 304A and the second access point 304B may provide WLAN service coverage area 302A and WLAN service coverage area 302B, respectively. The WLAN service coverage area 302A and the WLAN service coverage area 302B may each represent respective physical regions within which a client station may receive and decode transmissions from the corresponding access point, for example, broadcast management frames or downlink data frames provided by the access point. For example, as shown in FIG. 3, the WLAN service coverage area 302A at least partially overlaps with the WLAN service coverage area 302B creating an overlapping region 336. The client station 318A and the client station 332A are located within the overlapping region 336. The client station 318A and the client station 318B are associated with the WLAN service coverage area 302A provided by the first access point 304A. The client station 332A and the client station 332B are associated with the WLAN service coverage area 302B provided by the second access point 304B.

As shown in FIG. 3, the client station 318A and the client station 332A may receive a data unit from either or both the AP 304A and the AP 304B. The client station 318B may receive a data unit only from AP 304A. The client station 332B may receive a data unit only from AP 304B. The client stations 318A-B, 332A-B may be configured for determining the BSS color parameters of incoming data units that indicate the transmitter of the data unit, and may report the determined BSS color parameters to their respective APs and/or to a network management device 334.

By way of example, the client station 318A cannot rely upon BSS color parameters to determine which access point transmitted the data unit if both the first access point 304A and the second access point 304B have a same value for their respective BSS color parameters (e.g., a “color collision”). For example, the client station 318A may determine that the first access point 304A and the second access point 304B have the same value for their respective BSS color parameters and may generate a notification frame for the first access point 304A indicating the color collision. The first access point 304A, or the network management device 334, may determine a new value for the BSS color parameter of the first wireless local area network associated with the WLAN service coverage area 302A and change the BSS color parameter of the first wireless local area network associated with the WLAN service coverage area 302A. The first access point 304A and/or the second access point 304B may determine that the first access point 304A and/or the second access point 304B are providing a wireless local area network using different BSS color parameters and send a notification message to the network management device 334 indicating the different BSS color parameters. The client station 318A may determine that the first access point 304A and the second access point 304B have a different value for their respective BSS color parameters and may generate a notification frame for the first access point 304A indicating the different BSS color parameters.

One or both of the client stations 318A and/or 332A may be configured for processing BSS color parameters, but may not be configured for spatial reuse transmissions. Accordingly, while the client stations 318A and/or 332A may be configured to determine a BSS color parameter (e.g., in a PHY header of a packet) and report the BSS color parameter to an AP, the client station will wait for a clear channel before communicating, regardless of whether the BSS color parameter indicates that an incoming transmission on the same channel is an OBSS transmission or an intra-BSS transmission. For example, the first access point 304A may continue to send data to the client station 318A, expecting an acknowledgement message, however the client station 318A will not send the acknowledgement message until the channel is clear. In contrast, client station 318B is not within the overlapping region 336, and accordingly will not receive data units intended for client stations of AP 304B and may send an acknowledgement message to the AP 304A using the clear channel.

For example, the system 300 may comprise the network management device 334. For example, the network management device 334 may be implemented as an instance of one or more of the access points 104A and/or 104B or the network management device 134 described above with reference to FIG. 1. The network management device 334, when present in the system 300, may manage the allocation of channels and/or BSS color parameters to access points within the system 300. For example, the first access point 304A may send an indication of increased latency to the network management device 334. For example, the first access point 304A may send an indication of amount of BSS color parameters detected to the network management device 334. For example, the first access point 304A may send an indication of a color collision to the network management device 334. The network management device 334 may be configured to determine a new value for the BSS color parameter for the first access point 304A and/or for the second access point 304B. The network management device 334 may be configured to transmit an instruction to the first access point 304A and/or to the second access point 304B to change the BSS color parameter to the newly determined BSS color parameter.

The network management device 334 and/or one or more of the access points 304A and/or 304B may be configured to execute a channel selection method to identify and/or assign a channel for use by one or more of the access points 304A and/or 304B. The network management device 334 and/or one or more of the access points 304A and/or 304B may be configured to determine the presence of the overlapping region 336 based on one or more of the client stations (e.g., client stations 318A, 332A) and/or the APs (e.g., the APs 304A-B) reporting the presence and/or receipt of multiple (different) BSS color parameters, a color collision, or both. The network management device 334 may be configured to execute the channel selection method based on the presence of the overlapping region 336.

The channel may be identified and/or assigned as part of initial setup of an access point, periodically, substantially in real-time, based on detection of different BSS color parameters, based on a color collision, based on a quantity of color collisions, based on an amount of interference, combinations thereof, and the like.

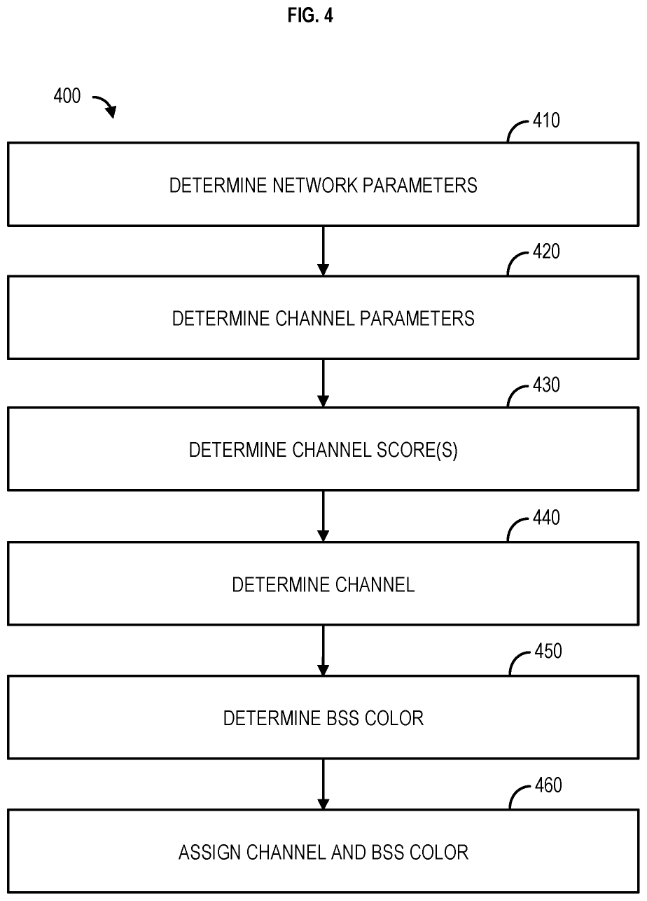

The channel selection method may utilize BSS color parameters to reduce co-channel interference (e.g., same channel) by causing one or more APs (e.g., one of APs 304A-B) to change to a different channel. FIG. 4 shows an example channel selection method 400. The channel selection method 400 may be completed by any one or more of the computing devices of FIGS. 1 and 3. At 410, one or more network parameters may be determined (e.g., collected) for surrounding networks. One or more channels may be scanned to determine the network parameters. The network parameters may comprise, for example, one or more of BSSIDs, SSIDs, IP addresses, MAC addresses, power levels, BSS color parameters, channel identifiers, signal strength (e.g., RSSI), combinations thereof, and the like.

At 420, one or more channel parameters may be determined (e.g., collected). The one or more channels may be scanned to determine the channel parameters. The channel parameters may comprise, for example, one or more of a channel utilization measurement, a number of networks operating on a channel, a number of unique BSS colors used on a channel, a signal strength(s) of a network(s) operating on a channel, combinations thereof, and the like.

At 430, one or more channel scores may be determined. A channel score may be determined based on one or more of the network parameters and/or the channel parameters. Channel score determination may take into account utilization percentages to prioritize channels with lower levels of overall network activity. Channel score determination may take into account the number of networks operating on a channel to prioritize channels with the lowest number of networks operating on them (e.g., counting BSSIDs/SSIDs), avoiding congested channels. Channel score determination may take into account the number of unique BSS colors for each channel to prioritize channels with a higher number of unique (e.g., unused) BSS colors, reducing co-channel interference by selecting channels where different networks are already using different BSS colors. Channel score determination may take into account the signal strength (e.g. received signal strength indicator (RSSI)) of networks operating on each channel to prioritize channels with lower average RSSI values, reducing the potential for interference from nearby networks with strong signals.

The one or more channel scores may be determined by selecting the least utilized channels and then determining the least used channels among the least utilized channels. Signal strength of the resulting channels may be multiplied with the inverse of a channel utilization percentage. Channels with higher signal strength and lower utilization will have higher sub-scores. The channel with the highest number of unique BSS Colors and the highest average signal strength*inverse channel utilization value may have the highest channel score and may be selected. For example, the RSSI (e.g., absolute value: a number between 30 and 100) may be multiplied by the (channel utilization percentage subtracted from 100 (to obtain the inverse value)). This result may be added to the number of available colors (0)-64) to obtain the channel score.

For example, if channel bonding is enabled for a channel, a channel score for an adjacent channel may be added to the channel for which channel bonding is enabled.

At 440, a channel may be determined based on the one or more channel scores. The channel may be determined based on being associated with a highest channel score, relative to other channels. The determined channel may represent one or more of, a least utilized channel based on the channel utilization measurements, a least used channel associated with a lowest number of networks operating on the channel, a channel with a higher number of unique (e.g. unused) BSS colors available, a channel with lower average RSSI values of operating networks operating on the channel, combinations thereof, and the like.

At 450, a BSS color parameter may be determined based on available BSS colors for the determined channel. The BSS color parameters may be determined based on a random selection of unused BSS color parameters associated with the determined channel. Continuous (e.g., regular, periodic) monitoring of BSS color parameter usage may be used to determine available BSS color parameters.

At 460, an AP (e.g., one or more of APs 304A-B) may be assigned the determined channel and the BSS color parameter for use in communications with client stations. For example, the network management device 334 may be configured to transmit an instruction to the first access point 304A and/or to the second access point 304B to change channels to the determined channel and to use the determined BSS color parameter, thus reducing interference in the overlapping region 336. The instruction may be, for example, a channel switch announcement in a beacon or a management action frame. An AP can inform all of its associated client stations about a BSS color change in an action frame referred to as a BSS color change announcement frame. The BSS color change information can optionally also be included in beacons, probe responses, and reassociation response frames.

The channel selection method provides a robust and intelligent channel selection mechanism, particularly suited for dense Wi-Fi environments. By combining network parameters and channel parameters, including BSS color parameters, interference is minimized, improving overall network performance, user experience, and more efficient use of an available Wi-Fi spectrum. Network and/or channel performance may be monitored to determine if performance and/or stability deviates from a threshold and the channel selection method may be re-executed. In particular, the channel selection method may reduce co-channel interference created by client stations that are not configured for spatial reuse transmission, by moving communication to a different channel that is more likely to be clear for transmission.

Returning to FIG. 3, the network management device 334 and/or one or more of the access points 304A and/or 304B may be configured to execute a transmit power control method to adjust, or cause adjustment of, a transmit power of one or more of the access points 304A and/or 304B. The network management device 334 and/or one or more of the access points 304A and/or 304B may be configured to determine the presence of the overlapping region 336 based on one or more of the client stations and/or the APs reporting the presence of multiple (different) BSS color parameters, a color collision, or both. The network management device 334 may be configured to execute the channel selection method based on the presence of the overlapping region 336 to adjust the first WLAN associated with the WLAN service coverage area 302A to no longer encompass the client station 332A and/or to adjust the second WLAN associated with the WLAN service coverage area 302B to no longer encompass the client station 318A. The transmit power may be determined as part of initial setup of an access point, periodically, substantially in real-time, based on detection of different BSS color parameters, based on a color collision, based on a quantity of color collisions, based on an amount of interference, based on network degradation, or any combination thereof.

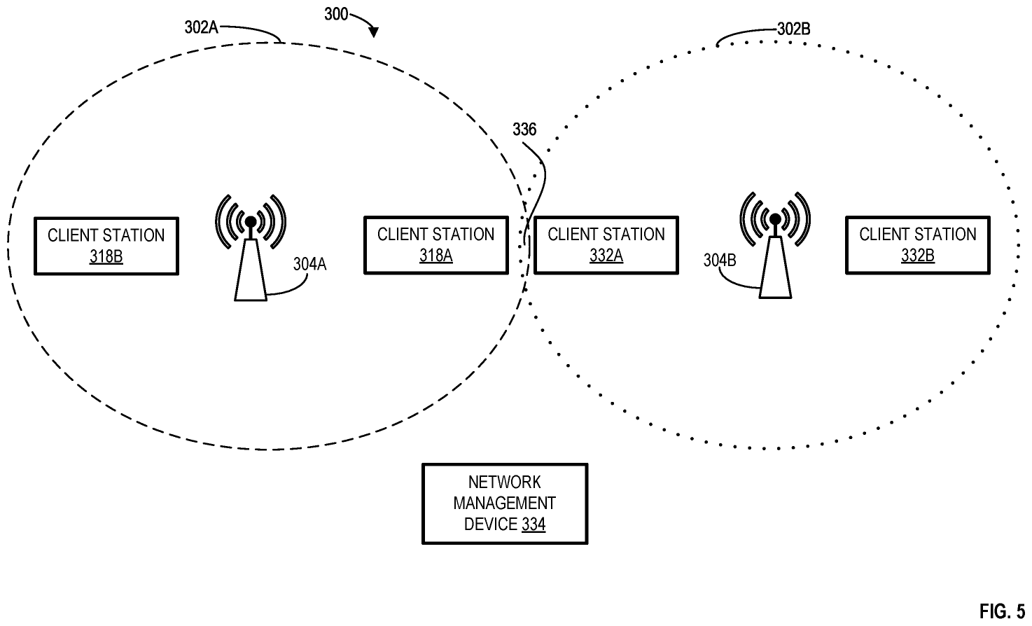

As shown in FIG. 5, the transmit power of the access points 304A and/or 304B may be adjusted such that the first access point 304A and the second access point 304B provide WLAN service coverage areas 302A and WLAN service coverage area 302B, respectively such that, while still creating an overlapping region 336, the client station 318A and the client station 332A are no longer located within the overlapping region 336. The client station 318A is associated only with the first WLAN associated with the WLAN service coverage area 302A provided by the first access point 304A and the client station 332A is only associated with the second WLAN associated with the WLAN service coverage area 302B provided by the second access point 304B. As the client stations are only within communication range of assigned APs, BSS color collisions and co-channel interference are mitigated and spatial reuse may now be enabled.

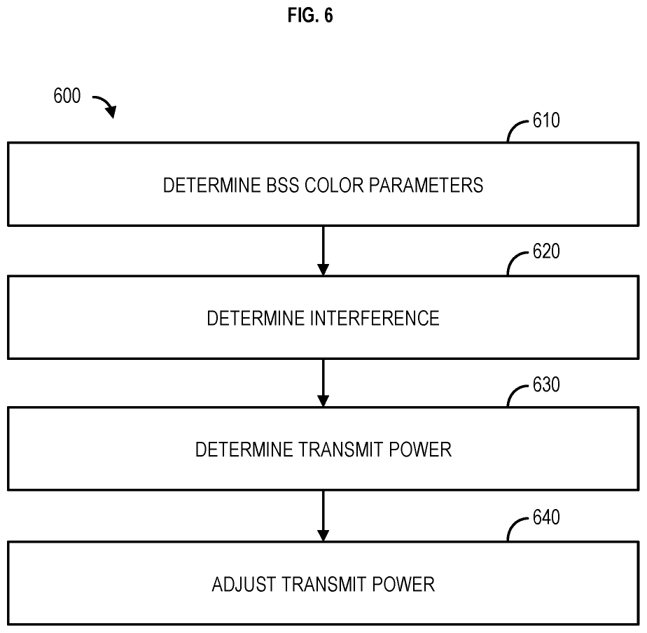

The transmit power control method may utilize BSS color parameters to reduce co-channel interference (e.g., same channel) by causing one or more APs to adjust transmit power. FIG. 6 shows an example transmit power control method 600. The transmit power control method 600 may be completed by any one or more of the computing devices of FIGS. 1 and 3. At 610, BSS color parameters may be determined for a plurality of APs. The BSS color parameters may be determined for a plurality of APs within an interference range. The interference range may comprise a distance within which it is likely that two or more APs will have overlapping network coverage. For example, BSS color parameters may be determined for the first access point 304A and the second access point 304B as shown in FIG. 3.

The interference range may be dynamically calculated based on one or more parameters, including for example, one or more of: transmit power of highest powered AP, BSS color collision, channel utilization, environmental factors (such as distance and walls that may attenuate the signal), combinations thereof, and the like.

Returning to FIG. 6, at 620, an interference level between the plurality of APs may be determined. The interference level may be determined as between one AP of the plurality of APs and the remaining APs of the plurality of APs. For example, the interference level may be determined between a “local” AP and “neighboring” APs. The interference level may be determined based on the BSS color parameters. The interference level may be determined by identifying APs within the interference range associated with different BSS colors and/or a color collision. The interference level may be determined by identifying the “loudest” AP and examining packet retransmission rates, increased error rates, increase in latency and/or jitter, sudden drops in throughput, combinations thereof, and the like.

At 630, a transmit power for at least one AP of the plurality of APs may be determined. The transmit power may be determined for one or all APs of the plurality of APs. The transmit power may be determined for the “local” AP. The transmit power may be determined based on the interference level. For example, the interference level may comprise metrics such as high packet retransmission rates, increased error rates, increased latency/jitter, and/or sudden drops in throughput, which notifies the AP and/or network management device for potential transmit power adjustment. A new power level may be determined, which may be a fixed step size (e.g., +−1 dBm) or a calculation based on specific conditions, such as distance between APs, severity of interference, current and desired signal strength, combinations thereof, and the like.

The transmit power may be determined by calculating a total transmit power and a total distance of interfering APs, calculating an average transmit power and an average distance, calculating a scaling factor based on the average distance and the interference range, and calculating the transmit power by subtracting scaled average transmit power from the at least one AP's (e.g., the “local” AP) current transmit power. The adjustment to the transmit power should not result in a negative transmit power.

At 640, the transmit power of the at least one AP of the plurality of APs may be adjusted. For example, a notification may be sent to the at least one AP to cause the at least one AP to adjust the transmit power level. For example, the network management device 334 may send the notification to the access point 304A to cause the access point 304A to adjust the transmit power level of the access point 304A.

The transmit power control method enables dynamic adaptation of AP transmit power depending on the surrounding network environment. This adaptability leads to reduced interference between APs with different BSS color parameters, resulting in improved network performance and decreased energy consumption. In particular, the transmit power control method reduces co-channel interference created by client stations that are not configured for spatial reuse transmission, by adjusting transmit power levels of APs so as to reduce or eliminate overlapping regions of network coverage.

Returning to FIG. 3, one more of the client stations and/or one or more of the APs may be configured for processing BSS color parameters, but not configured for spatial reuse transmissions while one or more other client stations and/or one or more other APs may be configured both for processing BSS color parameters and for spatial reuse transmissions. The network management device 334 and/or one or more of the access points 304A and/or 304B may be configured to cause one or more APs that are configured for spatial reuse transmission to send a spatial reuse transmission to certain client stations (e.g., client stations 318A-B and/or client stations 332A-B) and not to certain other client stations (e.g., client stations 318A-B and/or client stations 332A-B) based at least in part on BSS color parameters.

The network management device 334 and/or one or more of the access points 304A and/or 304B may be configured to cause one or more of the access points 304A and/or 304B to selectively send spatial reuse transmissions to client stations. The network management device 334 and/or one or more of the access points 304A and/or 304B may be configured to determine whether a spatial reuse transmission may be sent to one or more of the client stations based on a spatial reuse status of the one or more client stations, the presence of multiple (different) BSS color parameters, a color collision, a power level associated with OBSS interference, combinations thereof, and the like. An SR directory (e.g., stored values of a data structure) may be generated comprising an entry for one or more APs and/or one or more client stations, indicating a type of device, a spatial reuse status, and associated power levels. The SR directory may be used to determine if an AP can send a spatial reuse transmission to a client station. The SR directory may be generated and/or updated as part of initial setup of an access point, periodically, substantially in real-time, based on detection of different BSS color parameters, based on a color collision, based on a quantity of color collisions, based on an amount of interference, combinations thereof.

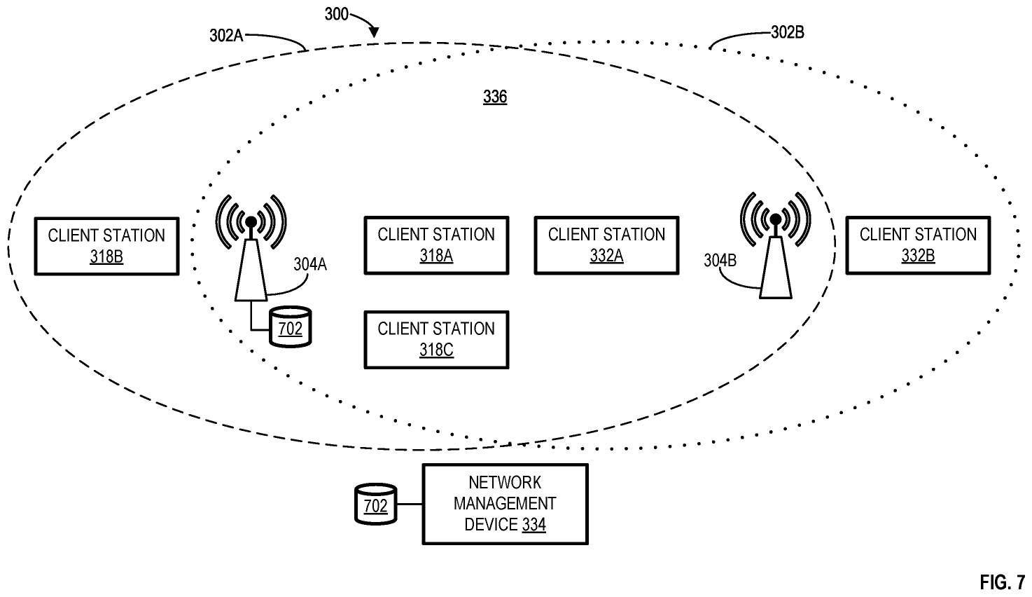

The use of the aforementioned SR directory addresses several co-channel interference issues. As shown in FIG. 7, for example, an AP (e.g., the AP 304A) configured for spatial reuse transmissions may detect the presence of a BSS color parameter of another AP (e.g., the AP 304B), indicating that the channel is not clear. The AP (e.g., the AP 304A) may send a spatial reuse transmission to a client station (e.g., the client station 318A) despite the channel not being clear. However, the client station (e.g., the client station 318A) that receives the spatial reuse transmission may not itself be configured to send spatial reuse transmission and will, accordingly, have to wait until the channel is clear to respond to the AP (e.g., the AP 304A). The AP (e.g., the AP 304A) may repeat sending the spatial reuse transmission as a timely acknowledgement message was not received, slowing throughput on this channel and creating further co-channel interference for other communication devices.

In another example, an AP (e.g., the AP 304A) configured for spatial reuse transmissions may detect the presence of a BSS color parameter of another AP (e.g., the AP 304B), indicating that the channel is not clear. The AP (e.g., the AP 304A) may send a spatial reuse transmission to a client station (e.g., the client station 318C) despite the channel not being clear. The client station (e.g., the client station 318C) that receives the spatial reuse transmission may be configured to send spatial reuse transmission and will respond to the AP (e.g., the AP 304A) at the earliest spatial reuse transmission opportunity. The AP (e.g., the AP 304A) will not need to repeat sending the spatial reuse transmission as a timely acknowledgement message will be received from the client station (e.g., the client station 318C).

The AP 304A may be configured to selectively send a spatial reuse transmission to a client station based on an SR directory 702. The SR directory 702 may comprise one or more records indicating a spatial reuse status for devices in communication with, or in communication range of, with the AP 304A. Each AP may comprise or otherwise have access to the SR directory 702 or its own SR directory. Similarly, the network management device 334 may comprise or otherwise have access to the SR directory 702 or its own SR directory, each of which may indicate a spatial reuse status for devices in communication with, or in communication range of, one or more APs.

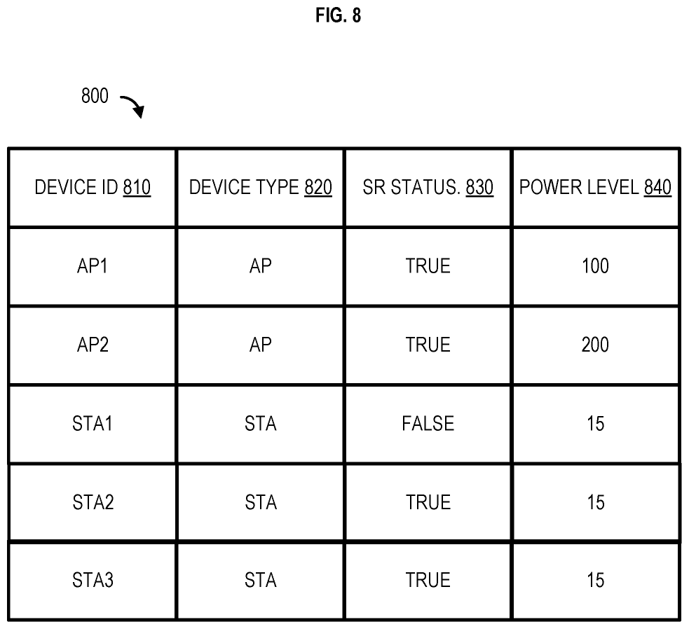

FIG. 8 shows an example SR directory 800. The example SR directory 800 indicates an identifier of a communication device 810, a type of communication device 820, a spatial reuse status 830, and a power level 840. The identifier of a communication device 810 may be any identifier capable of distinguishing one communication device from another communication device. The type of communication device 820 may identify whether the communication device is an AP or a client station (STA). The spatial reuse status 830 may indicate whether spatial reuse is enabled or disabled for the particular communication device. The power level 840 may comprise one or more spatial reuse power levels. Managing the power levels indicated in the power level 840 column permits spatial reuse to extend and/or avoid use of CSMA/CA-Clear Channel techniques. The power level 840 may be, for example, a value representing an amount of mW used to transmit a signal. The example SR directory 800 may comprise a list of client stations each AP is transmitting to (excluding conflicting STAs) (not shown).

Returning to FIG. 7, the AP 304A may identify the client station 318A as “STA1” in the SR directory 702 (e.g., the SR directory 800), determine that the client station 318A does not have spatial reuse enabled, and withhold sending spatial reuse transmissions to the client station 318A if the AP 304A detects a packet on the channel that corresponds to an OBSS transmission associated with the AP 304B. The AP 304A may identify the client station 318C as “STA3” in the SR directory 702, determine that the client station 318C has spatial reuse enabled, and send spatial reuse transmissions to the client station 318C if the AP 304A detects a packet on the channel that corresponds to an OBSS transmission associated with the AP 304B.

The use of the SR directory 702, 800 in such a fashion results in the efficient management of Wi-Fi communication in high-density environments where some client stations are not spatial reuse enabled, leading to potential communication conflicts and reduced network performance. In dense Wi-Fi environments, such as amusement parks and apartment complexes, multiple access points and client stations are located in close proximity. When these communication devices communicate on the same channel, it can cause interference and reduce overall network performance. Spatial reuse and BSS coloring are Wi-Fi 6 and Wi-Fi 7 features designed to mitigate interference and improve network efficiency. However, not all devices have spatial reuse enabled, leading to potential communication conflicts between APs and client stations.

The network management device 334 and/or one or more of the access points 304A and/or 304B may be configured to generate and/or use an SR directory for selective spatial reuse transmission by one or more of the access points 304A and/or 304B. The network management device 334 and/or one or more of the access points 304A and/or 304B may be configured to generate and/or use the SR directory based on one or more of the client stations and/or the APs reporting or detecting the presence of multiple (different) BSS color parameters, a color collision, or both. The network management device 334 may be configured to execute the channel selection method based on the presence of any communication device having spatial reuse disabled.

The SR directory (e.g., SR directory 702, 800) may be generated and/or used as part of initial setup of an access point, periodically, substantially in real-time, based on detection of different BSS color parameters, based on a color collision, based on a quantity of color collisions, based on an amount of interference, combinations thereof, and the like.

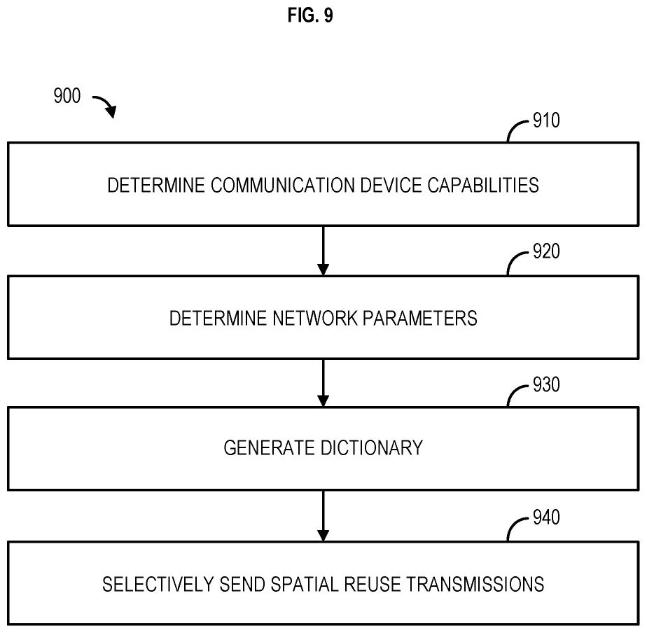

FIG. 9 shows an example method 900 for generating and using an SR directory (e.g., SR directory 702, 800) for selective spatial reuse transmission. The method 900 may be completed by any one or more of the computing devices of FIGS. 1 and 3. At 910, one or more capabilities of one or more communication devices (e.g., APs and/or client stations) may be determined. The one or more capabilities may comprise, for example, a spatial reuse status. The spatial reuse status may be determined using, for example, the Spatial Reuse subfield of a frame sent by an AP and/or a client station.

At 920, one or more network parameters may be determined (e.g., collected, received, detected) for surrounding networks. One or more channels may be scanned to determine the network parameters. The network parameters may comprise, for example, one or more of BSSIDs, SSIDs, IP addresses, MAC addresses, power levels, BSS color parameters, channel identifiers, signal strength (e.g., RSSI), combinations thereof, and the like.

At 930, an SR directory may be generated or updated. The SR directory may be generated based on the one or more capabilities of the one or more communication devices and one or more of the network parameters associated with the one or more communication devices. The SR directory may take the form of a data structure, such as a table. The SR directory may comprise, for example, one or more of an identifier of a communication device, a type of communication device, a spatial reuse status, a power level, an identifier(s) of communication devices (e.g., client stations) in communication with an AP, combinations thereof, and the like.

At 940, a spatial reuse transmission may be selectively sent. The spatial reuse transmission may be selectively sent by an AP. A network management device (e.g., network management device 334) may cause the spatial reuse transmission to be selectively sent by an AP. The spatial reuse transmission may be selectively sent based on the SR directory. Selectively sending the spatial reuse transmission may be based on analyzing the SR directory for conflicts. Communication devices (e.g., client stations) with spatial reuse enabled may be identified and spatial reuse transmissions sent to such communication devices.

Communication devices (e.g., client stations) without spatial reuse enabled may be identified and associated power levels and OBSS interference determined. Spatial reuse transmissions may be sent to such communication devices, despite not having spatial reuse enabled, if the associated power levels and OBSS interference do not satisfy a threshold, if latency has increased, and/or dropped packets are occurring, combinations thereof, and the like.

Communication devices (e.g., client stations) without spatial reuse enabled and that are receiving power from OBSS communications that exceed a threshold may be identified. Spatial reuse transmissions may not be sent to such communication devices. The threshold may be CSMA/CA Carrier Sense Threshold (CST) and Clear Channel Assessment (CCA), (Energy Detect and Carrier Sense), as is known in the art.

The use of the SR directory for selective spatial reuse transmission improves the Wi-Fi experience in high-density environments by intelligently managing spatial reuse and minimizing communication conflicts between devices with and without spatial reuse capability.

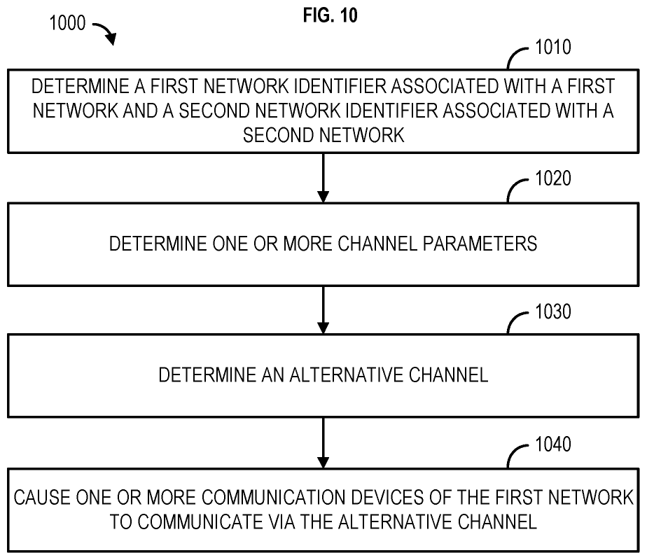

FIG. 10 shows an example method 1000. The example method 1000 may be executed in whole or in part by one or more communication devices. The one or more communication devices may be one or more of, a client station, an access point, a network management device, combinations thereof, and the like. At 1010, a first network identifier associated with a first network and a second network identifier associated with a second network may be determined. The first network and the second network may be communicating on a same channel or a different channel. Some or all (e.g., a portion) of one or more communication devices of the first network may not be configured for spatial reuse transmission. Some or all (e.g., a portion) of one or more communication devices of the second network may not be configured for spatial reuse transmission. Some or all (e.g., a portion) of one or more communication devices of the first network may be configured for spatial reuse transmission. Some or all (e.g., a portion) of one or more communication devices of the second network may be configured for spatial reuse transmission.

The first network identifier may comprise a Basic Service Set (BSS) color parameter. The second network identifier may comprise a BSS color parameter. The first network identifier may comprise a first Basic Service Set (BSS) color parameter and the second network identifier may comprise a second BSS color parameter. The first network identifier and the second network identifier may be the same. The first network identifier and the second network identifier may be different. The method 1000 may further comprise determining that the first BSS color parameter and the second BSS color parameter are or are associated with WLANs/networks that are overlapping basic service sets (OBSS).

Determining the first network identifier associated with the first network and the second network identifier associated with the second network may comprise receiving the first network identifier and the second network identifier from a single communication device of the first network or from a single communication device of the second network. Determining the first network identifier associated with the first network and the second network identifier associated with the second network may further comprise determining one or more network parameters. The one or more network parameters may comprise one or more of a BSSID associated with a communication device, an SSID associated with a communication device, an IP address associated with a communication device, a MAC address associated with a communication device, a power level associated with a communication device, a BSS color parameter associated with a network, a channel identifier, a signal strength associated with a channel, combinations thereof, and the like.

At 1020, one or more channel parameters may be determined. The one or more channel parameters may be determined based on the first network identifier and/or the second network identifier. Determining the one or more channel parameters may comprise scanning the same channel and a plurality of available channels. The one or more channel parameters may comprise a channel utilization measurement, a number of networks operating on a channel, a number of unique BSS colors used on a channel, or a signal strength(s) of a network(s) operating on a channel. Determining, based on the one or more channel parameters, the alternative channel may comprise determining a channel score for each channel of a plurality of available channels. Determining the channel score for each channel of the plurality of available channels may comprise determining one or more least utilized channels of the plurality of available channels, determining one or more least used channels of the one or more least utilized channels, determining a signal strength (e.g., RSSI) of the one or more least used channels (e.g., of all access points on each channel), and determining, based on the signal strength and a channel utilization parameter, the channel score.

At 1030, an alternative channel may be determined. The alternative channel may be determined based on the one or more channel parameters. Determining the alternative channel may comprise determining a channel of the plurality of available channels associated with a highest channel score as the alternative channel. Determining the alternative channel may comprise determining a channel of the plurality of available channels associated with a highest channel score and a highest number of unique network identifiers as the alternative channel.

At 1040 one or more communication devices of the first network (and/or one or more communication devices of the second network) may be caused to communicate via the alternative channel. Causing the one or more communication devices of the first network (and/or one or more communication devices of the second network) to communicate via the alternative channel may comprise sending a notification to an access point associated with the first network (and/or to an access point associated with the second network) to change communications to the alternative channel. Causing the one or more communication devices of the first network (and/or one or more communication devices of the second network) to communicate via the alternative channel may comprise sending a notification to a client station associated with the first network (and/or to a client station associated with the second network) to change communications to the alternative channel. Causing the one or more communication devices of the first network (and/or one or more communication devices of the second network) to communicate via the alternative channel may comprise an access point associated with the first network (and/or to an access point associated with the second network) switching to the alternative channel and sending a notification to one or more client stations associated with the first network (and/or one or more client stations associated with the second network) to switch to the alternative channel.

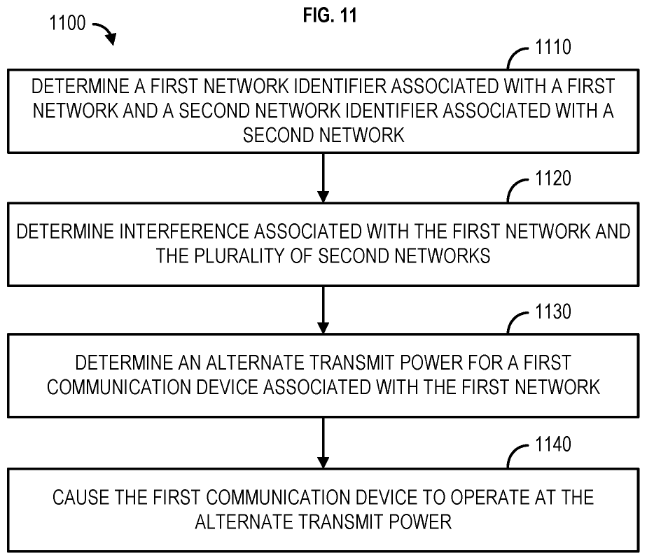

FIG. 11 shows an example method 1100. The example method 1100 may be executed in whole or in part by one or more communication devices. The one or more communication devices may be one or more of, a client station, an access point, a network management device, combinations thereof, and the like. At 1110, a first network identifier associated with a first network and a plurality of second network identifiers associated with a plurality of second networks may be determined. The first network and the plurality of second networks may be communicating on a same channel or a different channel. Some or all (e.g., a portion) of one or more communication devices of the first network may not be configured for spatial reuse transmission. Some or all (e.g., a portion) of one or more communication devices of the plurality of second networks may not be configured for spatial reuse transmission. Some or all (e.g., a portion) of one or more communication devices of the first network may be configured for spatial reuse transmission. Some or all (e.g., a portion) of one or more communication devices of the plurality of second networks may be configured for spatial reuse transmission.

The first network identifier may comprise a Basic Service Set (BSS) color parameter. The plurality of second network identifiers may comprise a plurality of second BSS color parameters. The first network identifier may comprise a first Basic Service Set (BSS) color parameter and the plurality of second network identifiers may comprise a plurality of second BSS color parameters. The first network identifier and the plurality of second network identifiers may be the same. The first network identifier and the plurality of second network identifiers may be different. The method 1100 may further comprise determining that the first BSS color parameter and at least a portion of the plurality of second BSS color parameters are or are associated with WLANs/networks that are overlapping basic service sets (OBSS).

Determining the first network identifier associated with the first network and the plurality of second network identifiers associated with a plurality of second networks may comprise receiving, by a network management device, the first network identifier and the plurality of second network identifiers from a single communication device of the first network.

At 1120, interference associated with the first network and the plurality of second networks may be determined. The interference may be determined based on the first network identifier and the plurality of second network identifiers. Determining the interference associated with the first network and the plurality of second networks may comprise determining that the first network identifier and the plurality of second network identifiers are different and determining that a first communication device associated with the first network and a plurality of communication devices associated with the plurality of second networks are within an interference range. The interference range may comprise a coverage area of the first network.

At 1130, an alternate transmit power for a first communication device associated with the first network may be determined. The first communication device may comprise an access point associated with the first network (e.g., providing a WLAN as the first network). The alternate transmit power may be determined based on the interference. Determining the transmit power for the first communication device associated with the first network may comprise determining a total transmit power and a total distance associated with the plurality of communication devices, determining, based on the total transmit powers and the total distances, an average transmit power an average distance, determining, based on the average transmit power and the average distance, a scaling factor, and determining a difference between a current transmit power of the first communication device and the scaling factor as the alternate transmit power.

At 1140, the first communication device may be caused to operate at the alternate transmit power. Causing the first communication device to operate at the alternate transmit power may comprise sending a notification to an access point associated with the first network to operate at the alternate transmit power.

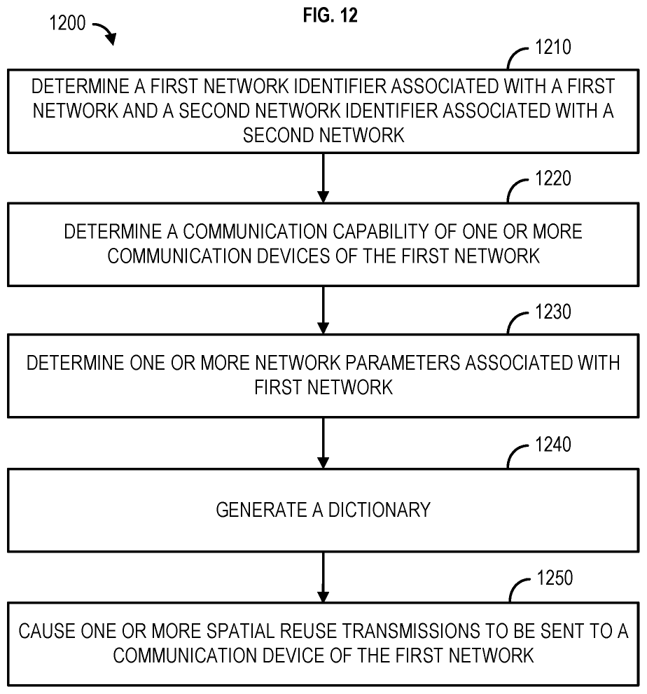

FIG. 12 shows an example method 1200. The example method 1200 may be executed in whole or in part by one or more communication devices. The one or more communication devices may be one or more of, a client station, an access point, a network management device, combinations thereof, and the like. At 1210, a first network identifier associated with a first network and a second network identifier associated with a second network may be determined. The first network and the second network may be communicating on a same channel or a different channel. Some or all (e.g., a portion) of one or more communication devices of the first network may not be configured for spatial reuse transmission. Some or all (e.g., a portion) of one or more communication devices of the second network may not be configured for spatial reuse transmission. Some or all (e.g., a portion) of one or more communication devices of the first network may be configured for spatial reuse transmission. Some or all (e.g., a portion) of one or more communication devices of the second network may be configured for spatial reuse transmission.

The first network identifier may comprise a Basic Service Set (BSS) color parameter. The second network identifier may comprise a BSS color parameter. The first network identifier may comprise a first Basic Service Set (BSS) color parameter and the second network identifier may comprise a second BSS color parameter. The first network identifier and the second network identifier may be the same. The first network identifier and the second network identifier may be different. The method 1200 may further comprise determining that the first BSS color parameter and the second BSS color parameter are or are associated with WLANs/networks that are overlapping basic service sets (OBSS). Determining the first network identifier associated with the first network and the second network identifier associated with the second network may comprise receiving the first network identifier and the second network identifier from a single communication device of the first network or from a single communication device of the second network.

At 1220, a communication capability of one or more communication devices of the first network (and/or the second network) may be determined. Determining the communication capability of one or more communication devices of the first network (and/or the second network) may comprise inspecting one or more packets associated with the one or more communication devices of the first network (and/or the second network). The communication capability may comprise a spatial reuse transmission capability.

At 1230, one or more network parameters associated with the first network (and/or the second network) may be determined. The one or more network parameters may comprise one or more of a BSSID associated with a communication device, an SSID associated with a communication device, an IP address associated with a communication device, a MAC address associated with a communication device, a power level associated with a communication device, a BSS color parameter associated with a network, a channel identifier, a signal strength associated with a channel, combinations thereof, and the like.

At 1240, an SR directory may be generated. The SR directory (e.g., the SR directory 702, 800) may be generated based on the communication capability and/or the one or more network parameters. Generating the SR directory may comprise generating a data structure indicating, for each communication device of the first network, one or more of an identifier of a communication device, a type of communication device, a spatial reuse status of a communication device, a power level of a communication device, combinations thereof, and the like.

At 1250, one or more spatial reuse transmissions may be caused to be sent to a communication device (e.g., a client station) of one or more communication devices of the first network (and/or the second network). Causing one or more spatial reuse transmissions to be sent may be based on the SR directory. Causing one or more spatial reuse transmissions to be sent to the communication device of one or more communication devices of the first network may comprise determining, by an access point of the first network, based on the first network identifier and the second network identifier, a spatial reuse transmission opportunity. Causing one or more spatial reuse transmissions to be sent to the communication device of one or more communication devices of the first network may comprise determining, based on the SR directory, that the communication device of the one or more communication devices of the first network is configured for spatial reuse transmission. Causing one or more spatial reuse transmissions to be sent to the communication device of one or more communication devices of the first network may comprise determining, based on the SR directory, that the communication device of the one or more communication devices of the first network (and/or the second network) is not configured for spatial reuse transmission and a power level associated with an OBSS communication is below a threshold

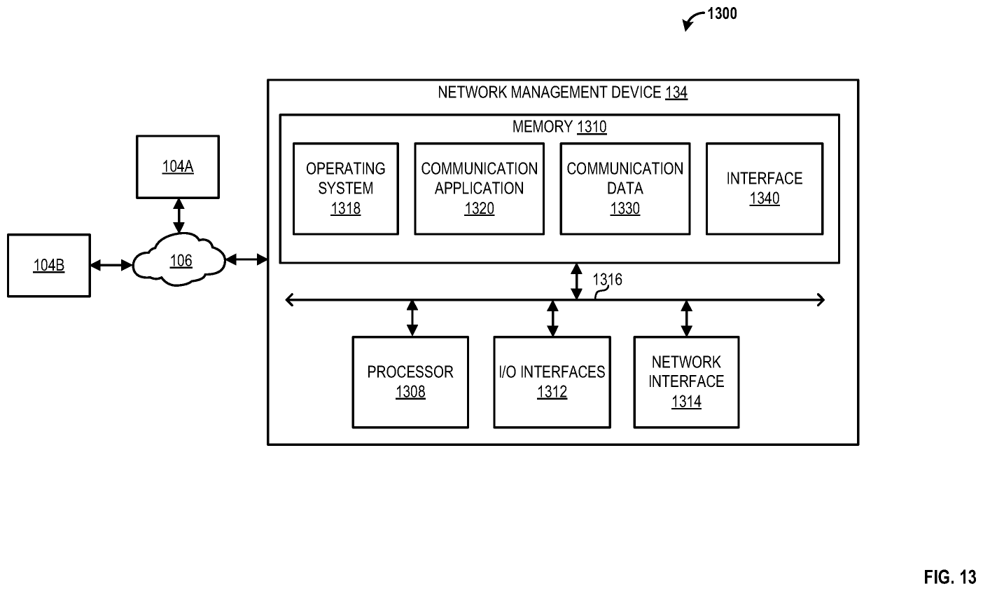

FIG. 13 is a block diagram depicting an environment 1300 comprising non-limiting examples of the network management device (e.g., computing device) 134 and the access points 104A and 104B connected through a network 1306. In an aspect, some or all elements of any described method may be performed on a computing device (such as the network management device 134) as described herein. The network management device 134 can comprise one or multiple computers configured to store one or more of a communication application 1320, communication data 1330, and to a user interface 1340 (e.g., via a web browser). Multiple access points 104A and 104B can connect to the network management device 134 through the network 1306 such as, for example, the Internet. A user of the network management device 134 may connect to the media communication application 1320 with the user interface 1340.

The network 1306 may be an electronic communication network that facilitates communication between the network management device 134 and the access points 104A and 104B. An electronic communication network includes a set of computing devices and links between the computing devices. The computing devices in the network use the links to enable communication among the computing devices in the network. The network 1306 can include routers, switches, mobile access points, bridges, hubs, intrusion detection devices, storage devices, standalone server devices, blade server devices, sensors, desktop computers, firewall devices, laptop computers, handheld computers, mobile telephones, and other types of computing devices.

For example, the network 1306 may include various types of links. For example, the network 1306 can include wired and/or wireless links, including BLUETOOTH, ultra-wideband (UWB), 802.11/b/g/n/ac, ZIGBEE, cellular, and other types of wireless links. Furthermore, the network 1306 is implemented at various scales. For example, the network 1306 can be implemented as one or more local area networks (LANs), metropolitan area networks, subnets, wide area networks (such as the Internet), or can be implemented at another scale. Further, the network 1306 may include multiple networks, which may be of the same type or of multiple different types.

The network management device 134 can be a digital computer that, in terms of hardware architecture, generally includes a processor 1308, memory system 1310, input/output (I/O) interfaces 1312, and network interfaces 1314. These components (1308, 1310, 1312, and 1314) are communicatively coupled via a local interface 1316. The local interface 1316 can be, for example but not limited to, one or more buses or other wired or wireless connections, as is known in the art. The local interface 1316 can have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 1308 can be a hardware device for executing software, particularly that stored in memory system 1310. The processor 1308 can be any custom made or commercially available processor, a central processing unit (CPU), an auxiliary processor among several processors associated with the network management device 134, a semiconductor-based microprocessor (in the form of a microchip or chip set), or generally any device for executing software instructions. When the network management device 134 is in operation, the processor 1308 can be configured to execute software stored within the memory system 1310, to communicate data to and from the memory system 1310, and to generally control operations of the network management device 134 pursuant to the software.

The I/O interfaces 1312 can be used to receive user input from and/or for providing system output to one or more devices or components. User input can be provided via, for example, a keyboard and/or a mouse. System output can be provided via a display device and a printer (not shown). I/O interfaces 1312 can include, for example, a serial port, a parallel port, a Small Computer System Interface (SCSI), an IR interface, an RF interface, and/or a universal serial bus (USB) interface.

The network interface 1314 can be used to transmit and receive from the network management device 134 or the access points 104A and 104B on the network 1306. The network interface 1314 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi), or any other suitable network interface device. The network interface 1314 may include address, control, and/or data connections to enable appropriate communications on the network 1306.

The memory system 1310 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 1310 may incorporate electronic, magnetic, optical, and/or other types of storage media. Note that the memory system 1310 can have a distributed architecture, where various components are situated remote from one another, but can be accessed by the processor 1308.

The software in memory system 1310 may include one or more software programs, each of which comprises an ordered listing of executable instructions for implementing logical functions. In the example of FIG. 13, the software in the memory system 1310 of the network management device 134 can comprise the communication application 1320 (or subcomponents thereof), the user interface 1340, and a suitable operating system (O/S) 1318. The operating system 1318 essentially controls the execution of other computer programs, such as the operating system 1318, the communication application 1320, and/or the user interface 1340, and provides scheduling, input-output control, file and data management, memory management, and communication control and related services.

For purposes of illustration, the communication data 1330 and application programs and other executable program components such as the operating system 1318 are illustrated herein as discrete blocks, although it is recognized that such programs and components can reside at various times in different storage components of the network management device 134. An implementation of the communication application 1320, the communication data 1330, and/or the user interface 1340 can be stored on or transmitted across some form of computer readable media. The communication data 1330 may include, for example, one or more SR directories as disclosed herein. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence techniques, such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with specific examples, it is not intended that the scope be limited to the particular examples set forth, as the examples herein are intended in all respects to be illustrative rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of examples described in the specification.

It will be apparent to those skilled in the art that various modifications and variations can be made without departing from the scope or spirit. Other examples will be apparent to those skilled in the art from consideration of the specification and practice described herein. It is intended that the specification and examples be considered as exemplary only, with a true scope and spirit being indicated by the following claims.

What is claimed is:

1. A method comprising:
determining, by a network management device, a first network identifier associated with a first network and a second network identifier associated with a second network, wherein the first network and the second network communicate on a same channel;
determining, based on the first network identifier and the second network identifier, one or more channel parameters;
determining, based on the one or more channel parameters, an alternative channel; and
causing one or more communication devices of the first network to communicate via the alternative channel.

2. The method of claim 1, wherein a portion of the one or more communication devices of the first network are not configured for spatial reuse transmission.

3. The method of claim 1, wherein determining, by the network management device, the first network identifier associated with the first network and the second network identifier associated with the second network further comprises determining one or more network parameters.

4. The method of claim 1, wherein the first network identifier comprises a first Basic Service Set (BSS) color parameter and wherein the second network identifier comprises a second BSS color parameter, method further comprising determining that the first BSS color parameter and the second BSS color parameter are overlapping basic service sets (OBSS).

5. The method of claim 1, wherein determining the one or more channel parameters comprises determining one or more of a channel utilization measurement, a number of networks operating on a channel, a number of unique BSS colors used on a channel, or a signal strength(s) of a network(s) operating on a channel.

6. The method of claim 1, wherein determining, based on the one or more channel parameters, the alternative channel comprises:
determining a channel score for each channel of a plurality of available channels; and
determining a channel of the plurality of available channels associated with a highest channel score as the alternative channel.

7. The method of claim 1, wherein determining, based on the one or more channel parameters, the alternative channel comprises:
determining a channel score for each channel of a plurality of available channels; and
determining a channel of the plurality of available channels associated with a highest channel score and a highest number of unique network identifiers as the alternative channel.

8. A method comprising:
determining, by a network management device, a first network identifier associated with a first network and a plurality of second network identifiers associated with a plurality of second networks, wherein the first network and the plurality of second networks communicate on a same channel;
determining, based on the first network identifier and the plurality of second network identifiers, interference associated with the first network and the plurality of second networks;
determining, based on the interference, an alternate transmit power for a first communication device associated with the first network; and
causing the first communication device to operate at the alternate transmit power.

9. The method of claim 8, wherein a portion of one or more communication devices of the first network are not configured for spatial reuse transmission.

10. The method of claim 8, wherein the first network identifier comprises a first Basic Service Set (BSS) color parameter and wherein the plurality of second network identifiers comprises a plurality of second BSS color parameters, the method further comprising determining that the first BSS color parameter and the plurality of second BSS color parameters are overlapping basic service sets (OBSS).

11. The method of claim 8, wherein determining, based on the first network identifier and the plurality of second network identifiers, the interference associated with the first network and the plurality of second networks comprises:
determining that the first network identifier and the plurality of second network identifiers are different; and
determining that the first communication device associated with the first network and a plurality of communication devices associated with the plurality of second networks are within an interference range.

12. The method of claim 11, wherein determining, based on the interference, the transmit power for the first communication device associated with the first network comprises:
determining a total transmit power and a total distance associated with the plurality of communication devices;
determining, based on the total transmit powers and the total distance, an average transmit power an average distance;
determining, based on the average transmit power and the average distance, a scaling factor; and
determining a difference between a current transmit power of the first communication device and the scaling factor as the alternate transmit power.

13. The method of claim 8, wherein causing the first communication device to operate at the alternate transmit power comprises sending a notification to an access point associated with the first network to operate at the alternate transmit power.

14. A method comprising:
determining, by a network management device, a first network identifier associated with a first network and a second network identifier associated with a second network, wherein the first network and the second network communicate on a same channel;
determining a communication capability of one or more communication devices of the first network;
determining one or more network parameters associated with the first network;
generating, based on the communication capability and the one or more network parameters, a spatial reuse (SR) directory; and
causing, based on the SR directory, one or more spatial reuse transmissions to be sent to a communication device of one or more communication devices of the first network.

15. The method of claim 14, wherein a first portion of the one or more communication devices of the first network are configured for spatial reuse transmission and a second portion of the one or more communication devices of the first network are not configured for spatial reuse transmission.

16. The method of claim 14, wherein determining, by the network management device, the first network identifier associated with the first network and the second network identifier associated with the second network comprises receiving the first network identifier and the second network identifier from a single communication device of the first network.

17. The method of claim 14, wherein the first network identifier comprises a first Basic Service Set (BSS) color parameter and wherein the second network identifier comprises a second BSS color parameter, the method further comprising determining that the first BSS color parameter and the second BSS color parameter are overlapping basic service sets (OBSS).

18. The method of claim 14, wherein determining the communication capability of the one or more communication devices of the first network comprises inspecting one or more packets associated with the one or more communication devices.

19. The method of claim 14, wherein the one or more network parameters comprises one or more of a BSSID associated with a communication device, an SSID associated with a communication device, an IP address associated with a communication device, a MAC address associated with a communication device, a power level associated with a communication device, a BSS color parameter associated with a network, a channel identifier, or a signal strength associated with a channel.

20. The method of claim 14, wherein generating, based on the communication capability and the one or more network parameters, the SR directory comprises generating a data structure indicating for each communication device of the first network, one or more of an identifier of a communication device, a type of communication device, a spatial reuse status of a communication device, or a power level of a communication device.

21. The method of claim 14, wherein causing, based on the SR directory, the one or more spatial reuse transmissions to be sent to the communication device of the one or more communication devices of the first network comprises determining, by an access point of the first network, based on the first network identifier and the second network identifier, a spatial reuse transmission opportunity.

22. The method of claim 21, wherein causing, based on the SR directory, the one or more spatial reuse transmissions to be sent to the communication device of the one or more communication devices of the first network comprises determining, based on the SR directory, that the communication device of the one or more communication devices of the first network is not configured for spatial reuse transmission and a power level associated with an OBSS communication is below a threshold.
